(19) United States
(12) Patent Application Publication
(10) Pub. No.: US 2007/0294646 A1
(43) Pub. Date: Dec. 20, 2007

(54) System and Method for Delivering Mobile RSS Content

(75) Inventor: Michael Timmons, San Jose, CA (US)

Correspondence Address: JOHN A. SMART, 708 BLOSSOM HILL RD., #201, LOS GATOS, CA, 95032-3503, US

(73) Assignee: SYBASE, INC., Dublin, CA (US)

(21) Appl. No.: 11/564,825

(22) Filed: Nov. 29, 2006

Related U.S. Application Data
(60) Provisional application No. 60/767,545, filed on Jun. 14, 2006.

(51) Int. Cl. G06F 3/14

(52) U.S. Cl. 715/864

(57) ABSTRACT

System and method for delivering mobile RSS content is described. The system, upon receiving a URL or feature list from a user of a feature phone, retrieves the target Web page and delivers to the feature phone Web content that is comparable to that which the user would enjoy at a desktop computer. In particular, the system of the present invention examines the target Web page to determine a particular page type and corresponding page strategy to apply. Based on the page strategy employed, the system may return to the user the content that they actually wanted from the target Web page. In this manner, the user need not purchase an expensive, high-end “smart phone” (e.g., Treo or the like) in order to retrieve Web content. The invention is particularly applicable in regions where high-end mobile devices are not practical (e.g., developing countries).

### CROSS REFERENCE TO RELATED APPLICATIONS

The present application is related to and claims the benefit of priority of the following commonly-owned, presently-pending provisional application(s): application Ser. No. 60/767,545 (Docket No. SYB/0127.00), filed Jun. 14, 2006, entitled “System and Method for Delivering Mobile RSS Content”, of which the present application is a non-provisional application thereof. The disclosure of the foregoing application is hereby incorporated by reference in its entirety, including any appendices or attachments thereof, for all purposes.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF INVENTION

1. Field of the Invention

The present invention relates generally to information processing for mobile devices and, more particularly, to a system and improved methodology for delivering RSS content to mobile devices.

2. Description of the Background Art

Computers are very powerful tools for storing and providing access to vast amounts of information. The first computers were largely stand-alone units with no direct connection to other computers or computer networks. Data exchanges between computers were mainly accomplished by exchanging magnetic or optical media such as floppy disks. Over time, more and more computers were connected to each other and exchanged information using Local Area Networks (“LANs”) and/or Wide Area Networks (“WANs”). Initially such connections were primarily amongst computers within the same organization via an internal network. More recently, the explosive growth of the Internet has provided access to tremendous quantities of information from a wide variety of sources.

The Internet comprises a vast number of computers and computer networks that are interconnected through communication links. The World Wide Web (WWW) portion of the Internet allows a server computer system to send graphical Web pages of information to a remote client computer system. The remote client computer system can then display the Web pages in a Web browser application (e.g., Netscape® Navigator, Mozilla Firefox, or Microsoft® Internet Explorer). To view a specific Web page, a client computer system specifies the Uniform Resource Locator (“URL”) for that Web page in a request (e.g., a HyperText Transfer Protocol (“HTTP”) request). The request is forwarded to the Web server that supports that Web page. When that Web server receives the request, it sends the specified Web page to the client computer system. When the client computer system receives that Web page, it typically displays the Web page using a browser application.

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls and other features. The HTML document may also contain URLs of other Web pages available on that server computer system or other server computer systems. Web pages may also be defined using other markup languages, including cHTML, XML, and XHTML.

Everyday, more and more information is made available via the Internet. The World Wide Web is made up of millions of “Web sites” with each site having a number of HTML pages (Web pages). Each HTML page usually has a number of Web objects, such as graphics, text, and “HyperText” references (URL's) to other HTML pages. Consider how users access information available via the Internet. A typical user may access the Internet from a desktop or laptop computer (e.g., in her office), and she may also use a mobile device (e.g., cellular phone) or other handheld computing device (e.g., personal digital assistant or PDA) for Internet access when traveling. Using Web browser software (e.g., Microsoft Internet Explorer or Mozilla Firefox), users can easily “surf” the World Wide Web to locate information of interest. For instance, a user may employ a Web browser to locate and obtain a quote for a particular stock on a financial services Web site, and then “click through” to one or more related financial articles. The challenge posed to users is how to efficiently locate, access, and use information that is relevant to them from amongst the huge quantities of materials that are available in a variety of different formats. This challenge is complicated by mobile devices, which typically have limited resources (e.g., limited memory and processor resources, and limited screen size). Of the vast amount of material available on the Web today, relatively little is suitable for viewing on commonly available mobile devices. Quite simply, the capabilities of the Web browsers on desktop or laptop computers have not been effectively duplicated on smaller devices.

In order to address that problem, present-day handheld computing devices (e.g., PDAs) are typically implemented as increasingly powerful miniature computers, with current models having fast processors and ample memory. Handheld computing devices do have sufficient computing resources to support full feature browsing software, albeit with some trade off for screen size (to preserve small form factor). Unfortunately, the miniaturization techniques that make these powerful computing devices highly portable also make them very expensive. Current mid- to high-end PDAs cost hundreds of dollars—more than the cost of a comparable desktop computer. Today, users are increasingly turning away from handheld computing devices, with that market experiencing declining growth rates.

In contrast to the contracting market for handheld computing devices, the market for mobile devices, especially cell phones, has exploded. Whereas handheld computing devices are typically very expensive, non-computing cell phones (“feature phones”) can be implemented as relatively inexpensive consumer devices. Of course being at a lower cost point, feature phones do not include extensive computing resources such as found on current handheld computing devices. Thus users face some trade-offs, especially with Internet access. With a desktop or laptop computer, or a feature-laden handheld device, a user can quickly access Web pages to retrieve information of interest. Feature phones in contrast lack any sort of Web browser capability, so Internet browsing (“Web surfing”) with such devices is not practical using current approaches. Notwithstanding that limitation, feature phones do include screens capable of displaying some degree of rich content. To date, however, there has been no effective means of getting Internet content on those displays.

What is needed is a solution that provides Web browsing capability to low-end mobile devices, such as feature phones and other “thin clients” devices. Such a solution would allow users of those devices to easily retrieve content from practically anywhere on the Web, notwithstanding the fact that the devices themselves have no Web browser capability. In this manner, Web browsing capability may be extended to a multitude of low-end devices, thus providing an inexpensive means for users to browse the Internet. The present invention fulfills this and other needs.

### SUMMARY OF INVENTION

A system and method for delivering mobile RSS content is described. The system of the present invention, upon receiving a URL or feature list from the user of a feature phone, retrieves the target Web page and delivers to the feature phone Web content that is comparable to that which the user would enjoy at a desktop computer. In particular, the system of the present invention examines the target Web page to determine a particular page type and corresponding page strategy to apply. Based on the page strategy employed, the system may return to the user the content that they actually wanted from the target Web page. In this manner, the user need not purchase an expensive, high-end “smart phone” (e.g., Treo or the like) in order to retrieve Web content. The invention is particularly applicable in regions where high-end mobile devices are not practical (e.g., developing countries).

In one embodiment, for example, a method of the present invention is described for delivering Web content to a limited-capability mobile device, the method comprises steps of: receiving from the limited-capability mobile device a request for information of interest from the Web; in response to the request, retrieving a target Web page containing the information of interest; examining the Web page to determine a particular page type; based on the particular page type, selecting a page strategy for extracting the information of interest from the Web page; based on the selected page strategy, extracting the information of interest from the Web page; formatting the information of interest, so that the information of interest is optimized for display on the limited-capability mobile device; and transmitting the formatted information of interest to the limited-capability mobile device, so that that information may be conveniently displayed on the limited-capability mobile device.

In another embodiment, for example, a system of the present invention for delivering Web content is described that comprises: a limited-capability mobile device; and server modules for: receiving from the limited-capability mobile device a request for information of interest from the Web; retrieving a target Web page containing the information of interest in response to the request; examining the Web page to determine a particular page type; selecting a page strategy for extracting the information of interest from the Web page based on the particular page type; extracting the information of interest from the Web page based on the selected page strategy; formatting the information of interest, so that the information of interest is optimized for display on the limited-capability mobile device; and transmitting the formatted information of interest to the limited-capability mobile device, so that that information may be conveniently displayed on the limited-capability mobile device.

In yet another embodiment, for example, a method of the present invention is described for on-demand formatting of a Web page into an RSS (Rich Site Summary) feed, the method comprises steps of: receiving a request from a client device for an RSS feed from the Web page; parsing the Web page to determine a page strategy for extracting information from the Web page for use as an RSS feed; based on the determined page strategy, extracting the information and reformatting it on-the-fly into an RSS feed; and transmitting the RSS feed to the client device.

### BRIEF DESCRIPTION OF DRAWINGS

FIG. 1 is a very general block diagram of a computer system (e.g., an IBM-compatible system) in which software-implemented processes of the present invention may be embodied.

FIG. 2 is a block diagram illustrating the basic approach of the present invention for delivering mobile RSS content.

FIG. 3 is a diagram illustrating new “text attributes” that are defined to assist with identifying more than text styles on Web pages, for converting HTML to RSS.

FIG. 4A is a bitmap screenshot illustrating a Mobile Browser Emulator constructed in accordance with the present invention.

FIG. 4B is a bitmap screenshot illustrating the synthesizes of additional “Navigation tags” to allow users to browse the Web without a full HTML browser.

FIGS. 5A-C are bitmap screenshots of different types of Web pages, which may be examined in accordance with the present invention to determine a page type and strategy.

FIGS. 6A-B comprise a single flowchart illustrating a method of the present invention for converting HTML to RSS.

FIG. 7 is a block diagram illustrating sample layout of a Web page.

FIG. 8 is a flowchart illustrating a method of the present invention for determining page layout types.

FIG. 9 is a flowchart illustrating a table strategy method of the present invention for processing a table page layout type (TABLE).

### DETAILED DESCRIPTION

Glossary

The following definitions are offered for purposes of illustration, not limitation, in order to assist with understanding the discussion that follows.

HTML: HTML stands for HyperText Markup Language, the authoring language used to create documents on the World Wide Web. HTML defines the structure and layout of a Web document by using a variety of tags and attributes. For further description of HTML, see e.g., “HTML 4.01 Specification”, a World Wide Web consortium recommendation dated Dec. 24, 1999, the disclosure of which is hereby incorporated by reference. A copy of this specification is available via the Internet (e.g., currently at www.w3.org/TR/REC-html40).

HTTP: HTTP is the acronym for HyperText Transfer Protocol, which is the underlying communication protocol used by the World Wide Web on the Internet. HTTP defines how messages are formatted and transmitted, and what actions Web servers and browsers should take in response to various commands. For example, when a user enters a URL in his or her browser, this actually sends an HTTP command to the Web server directing it to fetch and transmit the requested Web page. Further description of HTTP is available in “RFC 2616: Hypertext Transfer Protocol—HTTP/1.1,” the disclosure of which is hereby incorporated by reference. RFC 2616 is available from the World Wide Web Consortium (W3C), and is available via the Internet (e.g., currently at www.w3.org/Protocols/). Additional description of HTTP is available in the technical and trade literature, see e.g., Stallings, W., “The Backbone of the Web,” BYTE, October 1996, the disclosure of which is hereby incorporated by reference.

Network: A network is a group of two or more systems linked together. There are many types of computer networks, including local area networks (LANs), virtual private networks (VPNs), metropolitan area networks (MANs), campus area networks (CANs), and wide area networks (WANs) including the Internet. As used herein, the term “network” refers broadly to any group of two or more computer systems or devices that are linked together from time to time (or permanently).

RSS: RSS is short for RDF Site Summary or Rich Site Summary, an XML format for syndicating Web content. A Web site that wants to allow other sites to publish some of its content creates an RSS document and registers the document with an RSS publisher. A user that can read RSS-distributed content can use the content on a different site. Syndicated content includes such data as news feeds, events listings, news stories, headlines, project updates, excerpts from discussion forums or even corporate information.

URL: URL is an abbreviation of Uniform Resource Locator, the global address of documents and other resources on the World Wide Web. The first part of the address indicates what protocol to use, and the second part specifies the IP address or the domain name where the resource is located.

Winsock: Windows Sockets 2 (Winsock) is a Microsoft-provided interface that enables programmers to create advanced Internet, intranet, and other network-capable applications to transmit application data across the wire, independent of the network protocol being used. With Winsock, programmers are provided access to advanced Microsoft Windows networking capabilities such as multicast and Quality of Service (QOS). Winsock follows the Windows Open System Architecture (WOSA) model; it defines a standard service provider interface (SPI) between the application programming interface (API), with its exported functions and the protocol stacks. It uses the sockets paradigm that was first popularized by Berkeley Software Distribution (BSD) UNIX. It was later adapted for Windows in Windows Sockets 1.1, with which Windows Sockets 2 applications are backward compatible. Winsock programming previously centered around TCP/IP. Some programming practices that worked with TCP/IP do not work with every protocol. As a result, the Windows Sockets 2 API adds functions where necessary to handle several protocols. For further information regarding Winsock, see e.g., “Winsock Reference”, available from Microsoft Corporation, the disclosure of which is hereby incorporated by reference. A copy of this documentation is available via the Internet (e.g., currently at msdn.microsoft.com/library/default.asp?url=/library/en-us/winsock/winsock/winsock-reference.asp).

XML: XML stands for Extensible Markup Language, a specification developed by the World Wide Web Consortium (W3C). XML is a pared-down version of the Standard Generalized Markup Language (SGML), a system for organizing and tagging elements of a document. XML is designed especially for Web documents. It allows designers to create their own customized tags, enabling the definition, transmission, validation, and interpretation of data between applications and between organizations. For further description of XML, see e.g., “Extensible Markup Language (XML) 1.0”, (2nd Edition, Oct. 6, 2000) a recommended specification from the W3C, the disclosure of which is hereby incorporated by reference. A copy of this specification is available via the Internet (e.g., currently at www.w3.org/TR/REC-xml).

### Introduction

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows operating system. The present invention, however, is not limited to any one particular application or any particular environment. Instead, those skilled in the art will find that the system and methods of the present invention may be advantageously embodied on a variety of different platforms, including Macintosh, Linux, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware, or combinations thereof.

### Computer-Based Implementation

Basic System Hardware and Software (e.g., for Desktop and Server Computers)

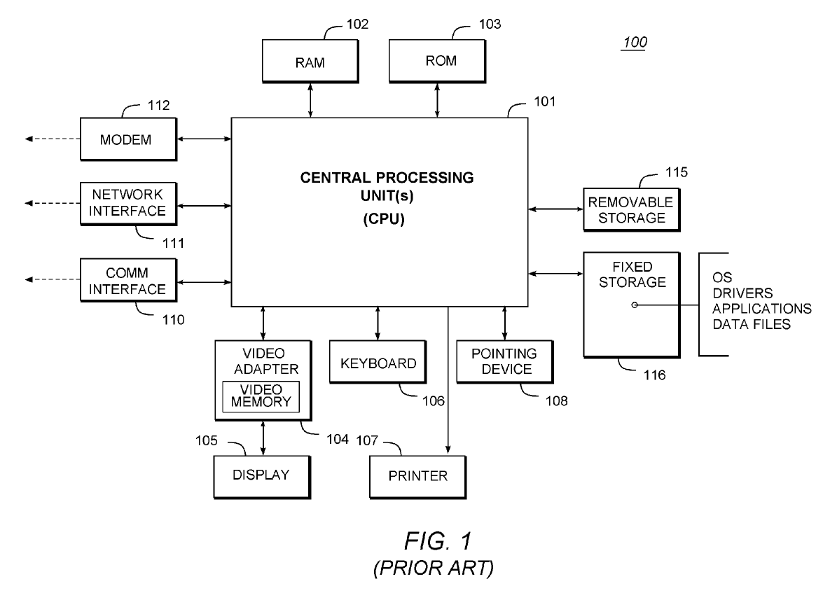

The present invention may be implemented on a conventional or general-purpose computer system, such as an IBM-compatible personal computer (PC) or server computer. FIG. 1 is a very general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor of the Intel Pentium family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP Laserjet printer (available from Hewlett Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

A software system is typically provided for controlling the operation of the computer system 100. The software system, which is usually stored in system memory (RAM) 102 and on fixed storage (e.g., hard disk) 116, includes a kernel or operating system (OS) which manages low-level aspects of computer operation, including managing execution of processes, memory allocation, file input and output (I/O), and device I/O. The OS can be provided by a conventional operating system, Microsoft Windows NT, Microsoft Windows 2000, Microsoft Windows XP, or Microsoft Windows Vista (Microsoft Corporation of Redmond, Wash.) or an alternative operating system, such as the previously mentioned operating systems. Typically, the OS operates in conjunction with device drivers (e.g., “Winsock” driver—Windows' implementation of a TCP/IP stack) and the system BIOS microcode (i.e., ROM-based microcode), particularly when interfacing with peripheral devices. One or more application(s), such as client application software or “programs” (i.e., set of processor-executable instructions), may also be provided for execution by the computer system 100. The application(s) or other software intended for use on the computer system may be “loaded” into memory 102 from fixed storage 116 or may be downloaded from an Internet location (e.g., Web server). A graphical user interface (GUI) is generally provided for receiving user commands and data in a graphical (e.g., “point-and-click”) fashion. These inputs, in turn, may be acted upon by the computer system in accordance with instructions from OS and/or application(s). The graphical user interface also serves to display the results of operation from the OS and application(s).

The above-described computer hardware and software are presented for purposes of illustrating the basic underlying computer components that may be employed for implementing the present invention. For purposes of discussion, the following description will present examples in which it will be assumed that there exists one Internet-enabled computer, such as a “server” (e.g., Web server), that provides information content to clients (e.g., desktop computers, laptop computers, mobile devices, and the like). The present invention, however, is not limited to any particular environment or device configuration. In particular, a client/server distinction is not necessary to the invention, but is used to provide a framework for discussion. Instead, the present invention may be implemented in any type of system architecture or processing environment capable of supporting the methodologies of the present invention presented in detail below.

### Overview

Current Mobile Browsers

Today there are two major groups of browsers for the handheld market. Both approaches require a “server” to pre-process Web pages for a reduced page markup browser. The first group of mobile browsers, referred to herein as the “client-server” approach, includes the following browser products: Opera-mini browser, AvantGo, and Minimo (reduced version of Mozilla/Firefox). The second group of “server” solutions relies on a server to transpose HTML into a modified form of the original Web page. Examples of this group include Squeezer (used by Askjeeves/Moreover). Squeezer divides a page into a serial stream of areas and unfortunately delivers a lot of unwanted content to the handheld device.

In accordance with the present invention, a third alternative is provided: the RSS Builder. The RSS Builder creates RSS feeds “on demand” for the user from pages that do not have RSS feeds. Benefits of this approach include:

### Providing “desired content” (i.e., only content with the highest probability of satisfying the user's information need will be downloaded).

### Reduced mobile handheld resources needed to display an RSS feed.

### Reduced mobile bandwidth needed as only XML/RSS will be downloaded.

### Tight integration with a single RSS reader that can be used to view site RSS feeds and “on demand” feeds.

Users are primarily concerned about obtaining the information they want, and are relatively unconcerned about what browser they use. In servicing these users, RSS and “feeds” are better suited to a small form factor than any “reduced set” HTML. Small “feature phones” will be around a long time before being replaced by more expensive “smart phones,” so it is important to address the needs of users of these devices.

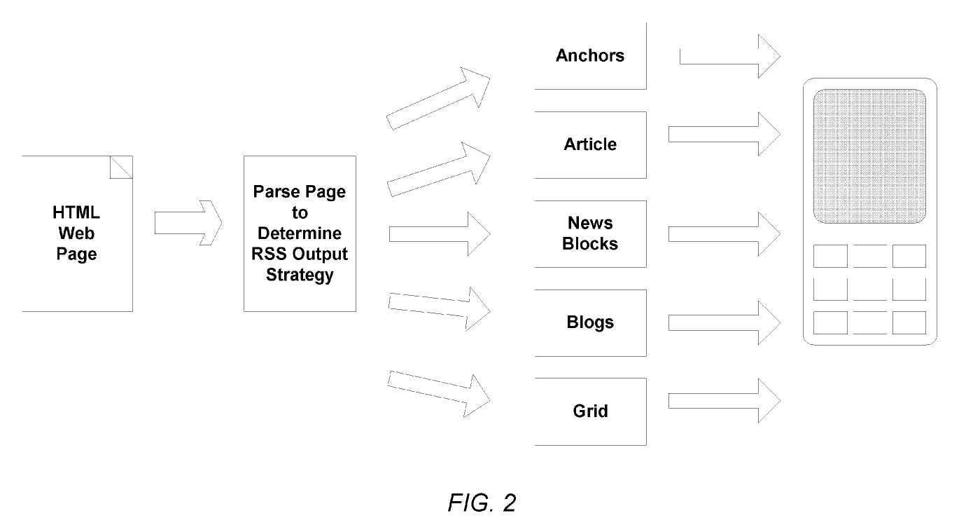

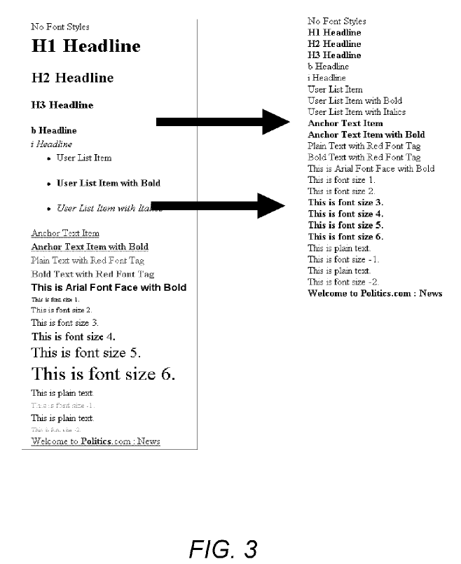

In accordance with the present invention, a user with a “feature phone” may easily retrieve content from practically anywhere on the Web, despite the fact that such a phone lacks any sort of Web browser capability. The basic approach is illustrated in FIG. 2. Upon receiving a URL or feature list from the user, the system of the present invention will retrieve the target Web page and deliver to the feature phone Web content that is comparable to that which the user would enjoy at a desktop computer. In particular, the system of the present invention examines the target Web page to determine a particular page type and corresponding page strategy to apply. Based on the page strategy employed, the system may return to the user the content that they actually wanted from the target Web page. In this manner, the user need not purchase an expensive, high-end “smart phone” (e.g., Treo or the like) in order to retrieve Web content. The invention is particularly applicable in regions where high-end mobile devices are not practical (e.g., developing countries).

### Browser-Less Mobile Content Delivery

Today, the world may be divided into low end “feature phone” and high-end “smart” phones. The feature phone device may be thought of as a server-based “thin-client.” The high end devices, on the other hand, are able to run sophisticated software, such as Sybase Content Capture Technology software (available from Sybase, Inc. of Dublin, Calif.). Sybase Content Capture Technology is a sophisticated toolset that can extract, aggregate and integrate information quickly and easily to provide a unique, targeted view of data. Delivering HTML Web content to both devices poses a difficult problem because of the limited display characteristics of the devices. The “RSS Builder” of the present invention provides a solution to this problem.

In basic operation, the RSS Builder receives a URL (of a target Web page) as input and returns an XML “RSS Feed” of that page as output. The approach has several advantages and possible applications. The approach allows the implementation of a “Discovery” feature that allows the user to search for RSS feeds by entering a URL. If no RSS feeds are available for that URL, the RSS Builder can return a RSS feed that is created in real-time to the user. Using a “feature phone,” the user can enter a URL or select a URL from a favorites list that will retrieve a RSS feed that is generated from the server. Using a “lightweight” RSS Reader (i.e., portion of the RSS Builder that is deployed to end-user devices), one can reach the “vast majority” of Web content using a modest feature phone (e.g., modest processing capability). The small size of the RSS Builder makes it possible to place a subset of RSS retrieval functions inside the SIM Card of an inexpensive feature phone. The full-featured (i.e., server side) RSS Builder can also reside as part of a server configuration and send the results of its content retrieval to any mobile device.

Carriers and manufacturers that are concerned with “spectrum bandwidth” requirements of their handheld devices can replace the existing HTML browser with the lightweight RSS Reader, thereby allowing their users to reach the content they desire using less “connect time” than when using a browser. Delivery time to download and render dynamic RSS feeds is also much faster than trying to “transpose” HTML to a small display format. In this manner, the RSS Builder of the present invention can extend the life of millions of feature phones.

Users of Sybase mFolio's desktop Web application can use “ultra-personalization” to reach their desired content on the Web. (Sybase mFolio is designed to take advantage of the increasing computational power of today's convergent devices, such as smartphones and PDAs, and helps carriers to offer any viewpoint of regular Web content on the handset easily, without additional coding.) Using the RSS Builder system, one can create an RSS feed of areas and articles for each mFolio “content page category” (sports, news, schedule, and the like) and then simply click on an RSS title to retrieve the article or area content. For example, the user may have several news articles on a single page tab called “World News.” In the handheld device, the user is now presented with a “World News” feed installed on his or her handheld. Clicking on World News, the user sees the title of each of his or her aggregated articles. Clicking on an article's title invokes an “article capture” feature, which returns the article text. From start to finish, no browser is needed. Adoption of this dynamic RSS may complement “viewpoint” capture features for high end phones. With the RSS Builder of the present invention, one may implement a range of solutions that spans any device with an RSS reader, or a simple browser that can display RSS feeds.

In accordance with the present invention, RSS search is also supported. Here, an ordinary Web search (e.g., “Google search”) may be rendered into an RSS feed, which in turn goes to any results page and returns a corresponding RSS feed for that page. In the case of Google searches, Google allows a user to set preferences via a personalization page to deliver a format friendly to mobile devices. However, Google is not able to help the user view content from sources which are themselves returned from a source. The RSS Builder of the present invention, in contrast, translates search results for a mobile device as well as translates pages listed in the search results for format on a mobile device. In this manner, the RSS Builder of the present invention provides mobile users complete access to the information that they really want.

If desired, the RSS search may be further divided based on result type. For example, Google results can be parsed by the RSS Builder so that users only sees results of the kind they desire. A user could, for instance, request a search for “articles only” or “headlines only.” In response to such a request, the RSS Builder may examine each result page and limit the corresponding RSS feed to only those pages that met the user's needs (i.e., desired type).

### HTML to RSS

In accordance with the present invention, an HTML to RSS conversion methodology is provided. In this regard, a portion of the methodology may be implemented using existing Sybase Content Capture Technology, including:

FEParser: used to extract “visible text” and “anchor text.”

Article capture: used to extract an article from a page.

CCL: used as the href for each RSS bullet; it points back to the source area, article, or page containing an article.

Additionally, new “text attributes” are defined to assist with identifying more than 70 text styles on Web pages, as illustrated on FIG. 3.

Page Pattern Recognition

When a page is requested by the mobile user, the page is parsed and each area on the page is surveyed to determine the number of “information” objects within that area. The results of the page survey are used to categorize the page into one of several strategies. Once the page category is defined the page is parsed again to generate the best possible RSS output for that particular Web page.

Strategies will not only determine the RSS parser (RSSBuilderParser) being used but also several other aspects. For example, the particular strategy will change the tags of the final output depending on the needs of the desired page. Style sheet information may also change depending on the display/browser requirements of the mobile or handheld device. The particular strategy will also determine the XSLT transform to apply when style sheets are used, as well as determining the navigation tags to take the user back to “Home” or to drill down to the next area or news group on a page.

FEPageMetrics

Page metrics are determined by a new FEPageMetrics class, which is designed as a “drop-into” component, for example for use in Sybase Content Capture Technology (lightweight content integration engine portion of the above-mentioned toolset). In operation, FEPageMetrics is passed a URL as part of a CachedURL object. In response, it retrieves the page and surveys the “most important” characteristics of the page. FEPageMetrics includes a “BuildFinal” method which returns a report of the page. For instance, the following is a sample report for CNN.com:

Source URL: http://www.cnn.com
Page Construction:

Javascript Includes: 2
StyleSheet Includes: 4
Framesets: 0
Web20: 0

Page Content:

Total Visible Text (not anchors): 3164
Text Runs > 50: 8
Text Runs > 100: 19
Text Runs > 200: 0
Text Runs > 400: 0
Date Runs: 0
Numeric Grid Cells: 0
Album (Similar) Images: 0
Title Runs: 0
Pointers to RSS Feeds: 2

Page Layout:

Total Images: 16
Table: 4
Anchor: 41
Script: 8
Applet: 0
Forms: 0

As shown, the page results are broken down into “Page Construction”, “Page Content” and “Page Layout” categories. In this manner, the page results or metrics may be used by the system to give a good identification of the underlying page type.

FEPageTerms

“Page Terms,” essentially comprising short lists of terms, are employed to help identify a particular page strategy. For example, “Page Terms” and corresponding strategies may be defined for “News Page,” “Finance Page,” “Catalog,” “Blog,” and “Navigation,” as follows:

News Page

World News, Sports, Top Stories, Technology, Politics, Health, Travel, Education, Law, Entertainment, World, Education

Finance Page

Business News, Markets, Quotes, Latest News, Companies, Technology, Finance

Catalog

Price, Lot, Description, Testimonials, Products, Shopping, Account, Hot

Blog

Trackback, Comments, Posted by

Navigation

More . . . , Next . . .

During system operation, each term list is loaded into a hashtable when the FEPageTerms (object) is initialized. As the page is parsed, runs of text less than a preset amount (e.g., 15 characters) are examined to reduce the amount of CPU time necessary to count special terms. The terms are saved in text files to be loaded by the FEPageTerms object and can be easily localized for languages other than English. In the currently preferred embodiment, the approach taken is to not build an exhaustive list of terms that might be helpful, but instead build the smallest list possible that will help identify a page type.

Navigation

In accordance with the present invention, dynamic navigation tags are added to the RSS content that is delivered to the mobile device. This provides the end user with a substantially improved means for navigating content, allowing the user to browse the Web without a full HTML browser. In this manner, the system of the present invention not only provides an HTML to RSS bridge for mobile devices but also the means to use a very small RSS reader as a “browser.”

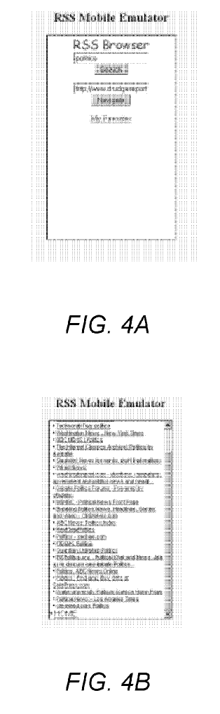

FIG. 4A illustrates a Mobile Browser Emulator constructed in accordance with the present invention. In response to input from the user (e.g., search term or URL), the RSSBuilder constructs a set of HTML pages that limit the size of the view area suitable for a mobile device. As shown in FIG. 4B, the Emulator synthesizes additional “Navigation tags” to allow the user to browse the Web without a full HTML browser.

### Page Strategies

As previously discussed, the results of the page survey are used to categorize a given target page into one of several strategies. The particular page strategy that a given page is categorized as determines the particular parser (i.e., particular version of RSSBuilderParser) that is applied to the page. In the currently preferred embodiment, the following page strategies are defined:

Anchor Page: more than 50% of the content is from anchor tags. (HTML uses the <a> (anchor) tag to create a link to another document.)

Blog page: anchors following by predictable runs of text with a clear pattern.

Aggregation page: anchors with short summary of source page.

Article: some anchors but the main feature is a “high score” text article.

Search results: lists of anchors with short description.

Photo pages: collection of photo pages from album sites.

mFolio page: photo pages comprising a collection of capture descriptions and CCL (Content Collection Language) statements that have been created by a desktop user of Sybase mFolio. (Sybase mFolio is a standalone, embeddable mobile application software and mobile data solution, that deliver highly focused, device-optimized mobile media browser and syndicated content to end users.)

The following presents specific sample URLs and corresponding rules for the various pages strategies.

### EXAMPLE #1

### Anchor Page

Example URL:

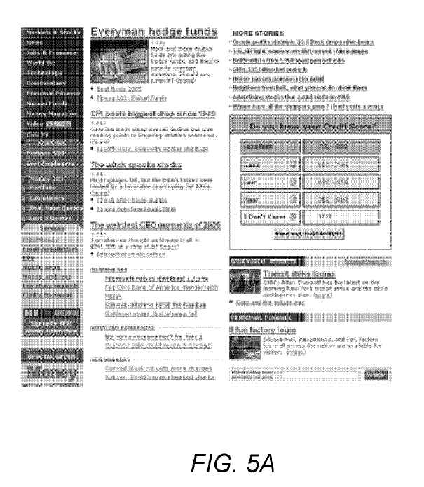

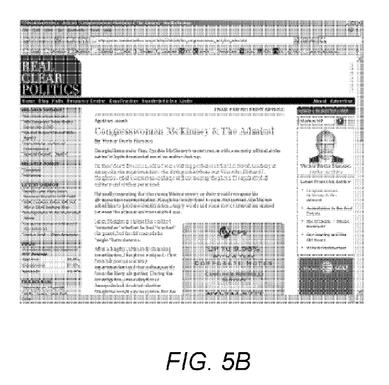

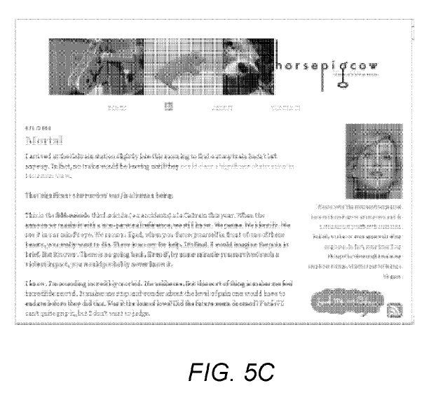

http://cnnfn.com (illustrated in FIG. 5A)

Rules:

Each anchor will have a RSS bullet title.

RSS title will have the original HREF of the cnnfn page article.

Ignore ads if possible.

Rank titles in RSS by anchor title style. For example, large fonts titles at the top of the RSS feed.

Ignore anchors to index pages such as “cnn.com/sports/” but instead favor content (e.g., cnn.com/news/1223334.htm).

The XML generated by the system of the present invention may be compared with the XML from the same page that is generated by target Web site (e.g., cnnfn.com). A high degree of overlap of articles in both their native XML form and generated XML form provides an indication that good results are being obtained on sites without an XML feed.

### EXAMPLE #2

### Article Page

Example URL:

http://www.realclearpolitics.com/articles/2006/04/the_congresswoman_and the_admi.html (illustrated in FIG. 5B)

Rules:

Looking for an “area” enclosed within a table with a large run of text.

The “article text run” should be the dominant run on the page. In other words, there generally should not be more than one article on a page. Styles for title and date timestamp are used to identify more than one article.

The article should not have “many” embedded anchors.

Looking for text styles that suggest an area such as 1 title style and something akin to a “body text” style.

A “date” style is also helpful.

Embedded tables are helpful in identifying advertisements which are not included in the returned article.

There is a “minimum text length” that will define an article.

### EXAMPLE #3

### Blog Page

Example URL:

http://www.horsepigcow.com/index.html (illustrated in FIG. 5C)

Rules:

Very similar to an article page but with a repeated pattern of date, title, and text run.

Should also have repeated patterns of blog terms such as “posted by”, “trackback” and “comments.”

### EXAMPLE #4

### “Unknown” Page

If a desired page is parsed and the system cannot with some degree of certainty identify the type of page, then the page is denoted as “unknown.” Unknown pages may be processed as follows. From the page contents present, the system can deliver a “best guess” of what is most important on that page, such as a list of anchors or “visible text.” In the currently preferred embodiment, the system displays a “Show More” option (e.g., displayed at the bottom of the mobile device screen) that the user may invoke to instruct the system to deliver another page part to the mobile device. In the event that the foregoing is not possible (e.g., because the system cannot define the best part of the page to deliver), the system may display additional options (e.g., “Show Links”, “Show Text”, and “Show Images”) allowing the mobile device user to select individual portions of the unknown page type.

### Server-Side Implementation

RSSBuilder Servlets

In the currently preferred embodiment, server-side program logic is implemented via RSSBuilder servlets. For deployment, for example, the RSSBuilder servlets can be easily added to Sybase Contentintegrator (available from Sybase, Inc. of Dublin, Calif.) by modifying the web.xml file with the servlet names and moving the servlets and related parser classes to the “classes” folder in core. (Sybase Content Integrator is an intuitive toolset built for software vendors that immediately adds content extraction, aggregation, and transformation functionality to existing applications so users have access to clean, targeted data.)

In an exemplary invocation, a servlet is called with the following parameters (arguments):

RSSSearch: localhost:8080/core/rsssearch?q=[search words]

RSSPlayback localhost:8080/core/rssplayback?a=[url of desired page to translate to RSS]

RSSDumpReport localhost:8080/core/rssdump?a=[url of desired page to translate to RSS]

The RSSSearch parameter specifies a search query and a target search site (e.g., Google) to perform the query; the results are translated into an RSS feed. The RSSPlayback parameter specifies the translation of any URL passed to it into a RSS feed. The RSSDump parameter specifies the determination of the “page metrics” of any URL passed to it.

### HTML to RSS Operation

The following description presents method steps that may be implemented using processor-executable instructions, for directing operation of a device under processor control. The processor-executable instructions may be stored on a computer-readable medium, such as CD, DVD, flash memory, or the like. The processor-executable instructions may also be stored as a set of downloadable processor-executable instructions, for example, for downloading and installation from an Internet location (e.g., Web server).

In accordance with the present invention, an improved method for converting HTML to RSS is provided by using a page pattern recognition approach. The present invention allows a user of a feature phone to enter a URL (or go to their favorites list) for a Web page of interest, whereupon the system of the present invention retrieves the Web page and examines every object on the page, in order to determine what type of page the Web page is.

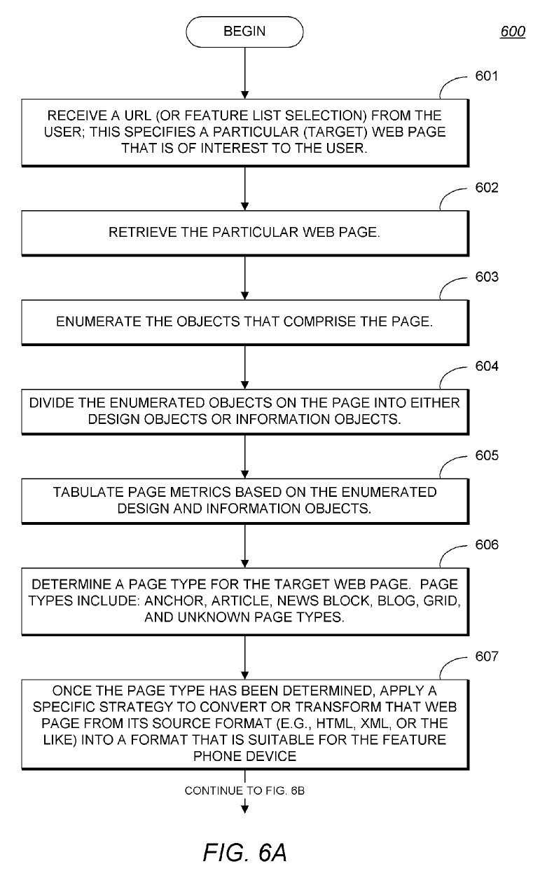

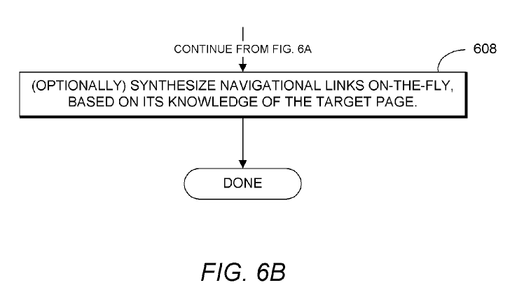

FIGS. 6A-B comprise a single flowchart illustrating a method 600 of the present invention for converting HTML to RSS. The method includes the following steps. At step 601, a URL (or feature list selection) is received from the user (i.e., user of feature phone device); this specifies a particular (target) Web page that is of interest to the user. In response to the user input, the method retrieves the particular Web page, at step 602. Now, at step 603, the method enumerates the objects that comprise the page, and then divides the enumerated objects on the page into either design objects or information objects, at step 604. A design object indicates where a particular item (e.g., image) is displayed. An information object, on the other hand, indicates what the corresponding information (content) is, including a type (e.g., image type) when applicable. As shown at step 605, the method may now tabulate page metrics based on the enumerated design and information objects. This allows the system to determine the page layout based on the enumerated design objects. For example, the method may determine how dense the page is, by looking at the design layout used on the page and how much whitespace is present. Similarly, the method may determine from the information objects the amount of text present at given portions of the page. For example, from the information objects the method may identify articles by long runs of text. Having enumerated all of the design objects and information objects for the page and tabulated corresponding page metrics, the system of the present invention may determine, to a high degree of accuracy, a page type for the target Web page, as indicated at step 606. In the currently preferred embodiment, page types include: anchor, article, news block, blog, grid, and unknown page types. Once the page type has been determined, the method may apply a specific strategy to convert or transform that Web page from its source format (e.g., HTML, XML, or the like) into a format that is suitable for the feature phone device, as shown at step 607.

As an additional feature of the present invention, the method may synthesize navigational links on-the-fly, based on its knowledge of the target page. As indicated at step 608, the above-described transformation is augmented by further processing the page to synthesize navigational links (i.e., links that were not present in the original page, as retrieved at step 602). In this manner, the present invention not only delivers information in a format suitable (i.e., viewable) for the feature phone, but also inserts navigational aids into the rendered page to provide the user with a means to navigate through that rendered content. For a rendered page that has an underlying page type of blog, for example, the method may synthesize a “Next” link that would retrieve the next blog comment. In a similar manner, a rendered article page may include a synthesized “Next” link that retrieves the next text block (e.g., 200-word text block) for the article. For an anchor page type (i.e., includes multiple anchors), the method may synthesize a “Home” link that navigates back to a base navigation page (determined based on page types). In this manner, the present invention provides the user with rich navigation capability without the feature phone itself requiring any additional software, such as browser software. As a result, the present invention provides the feature phone with browser-like capability without the requirement for an expensive processor and memory (ordinarily required for running browser software). Additionally, the approach economizes use of the screen “real estate” of the small device by avoiding the display of static glyphs (i.e., browser back, forward, and home glyphs), by instead using dynamically-generated navigational links whose appearance is controlled based on the actual design and content of the underlying Web page of interest to the user.

### FEParser Class

As described above, the FEParser is used during the HTML to RSS conversion to extract “visible text” and “anchor text.” Internally, FEParser forms the “base class” of all strategy page parsers, collectively referred to as FEParser.com. FEParser contains all necessary logic to parse and organize information and layout of the HTML page being parsed. Attributes of FEParser include the following:
A character-stream reader that allows characters to be pushed back into the stream.
Performance enhanced and tuned to insure the highest performance possible as pages are parsed.
Extensive collection of “navigation” and “security” methods that extend the generic Java libraries. These methods insure that we can easily reach web content that can be viewed by a popular web browser. Navigation methods also perform operations on URL (Uniform Resource Locator) strings.
Pre-process method to allow custom coding.
Page cache so that content that has been read once is maintained for a short time if a second rendering is necessary.
Post-parsing method to allow custom coding after parsing has taken place.
Methods to address problems associated with “absolute” and “relative” URL links within a page.
Method for “Unknown HTML Tag”
An extensive collection of “Parser Utilities” such as:
“GetAllAttributes” of a tag.
“GetRestofTags
“Get Text Until Next Tag”
Class methods for the majority of HTML tags such as TABLE, TR, TD, BR, P, etc.
Extensive code to handle Javascript page rendering.
Extensive code to handle FRAMESETS.
Extensive code to handle Cascading Style Sheets.
Extensive code for HTML Style tag.
Extensive code for HTML Comments.
Extensive code for HTML “visible text” on a page.

### FEPageMetrics Class

FEPageMetrics is a descendant class that overrides FEParser and is designed to “drop-into” any distribution of the Content Capture software. FEPageMetrics is passed a URL as part of the CachedURL object, retrieves the page, and survey the “most important” characteristics of the page. FEPageMetrics includes a “BuildFinal” method that returns a “Page Metrics” report of any page. A sample Page Metrics report for a typical page, for example, is as follows:

### Source URL:

### Page Type=DIV ARTICLE

### Rule Fired: 6

### Page Construction:

Javascript lncludes: 0

### StyleSheet Includes: 1

### Framesets: 4

### Web20: 4

### Page Content:

### Total Visible Text (not anchors): 11350

### Text Runs >50: 19

### Text Runs >100: 7

### Text Runs >200: 10

### Text Runs >400: 4

### First Pass Article: 0

### Date Runs: 4

### Numeric Grid Cells: 4

### Album (Similar) Images: 0

### Title Runs: 4

### Title Tags: 0

### H1: 0 H2: 0 H3: 0 H4: 0

### H1Text: 0 H2Text: 0 H3Text: 0 H4Text: 0

### H1Count: 0 H2Count: 0 H3Count: 0 H4Count: 0

### H1Len: 0 H2Len: 0 H3Len: 0 H4Len: 0

### H1Ratio: 0 H2Ratio: 0 H3Ratio: 0 H4Ratio: 0

### Pointers to RSS Feeds: 0

### Page Layout:

### Total Images: 35

### Frameset: 0

### Table: 32

### Divs: 47

### Repeating Divs: 0

### BLOG Post Related Divs: 0

### DIV Names: { }

### Anchor: 282

### Script: 32

### Applet: 0

### Forms: 0

Page Type

The results of a PageMetrics parse are used to determine the general type of page being parsed into several major categories: TABLE or DIV. The differences between TABLE and DIV tags are extensive. TABLE type of page layouts clearly outnumber the DIV tag pages and are built using software applications that have been around for years. DIV tags are usually built with newer tools and have many advantages over the older TABLE page design. By being able to identify the type of page and applying the correct page strategy we can extract information from the target page with accuracy.

Page Type: TABLE

Once the page is identified as a “TABLE” type, the system starts looking at the frequency and patterns on the page. To extract an article from the page it is necessary to identify “content breaks” on the page that identify the begin and end of each article. On blog pages, it is necessary to identify multiple “postings” on a page. This problem is made more difficult in that HTML tags such as H1 (Header 1), H2 (Header 2), etc. are not always used to define headers; also, other styles such as font tags are not always helpful in identifying patterns. To improve the accuracy of TABLE page parsing it is necessary to look at headers and other content breaks, and also to keep count of what is being rendered between the tags.

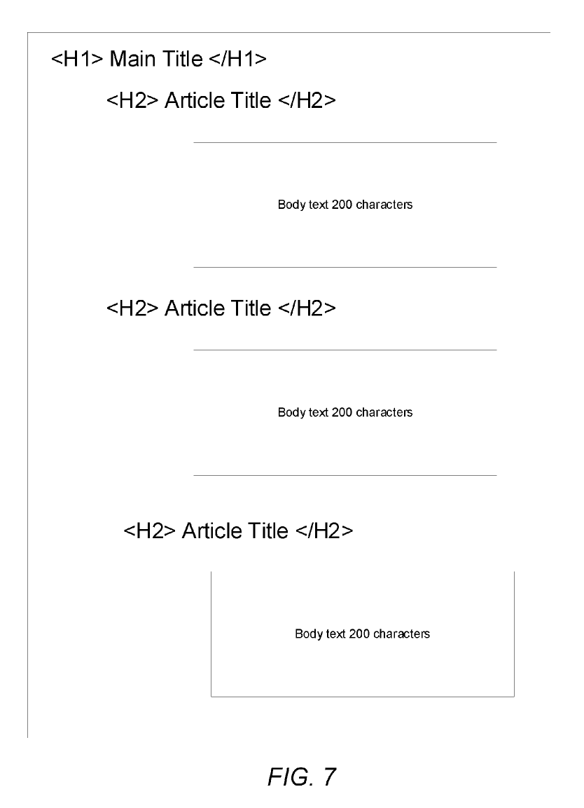

Consider the page shown in FIG. 7, for example. In the page there is a H1 tag and 3 H2 tags. The strategy applied to this page focuses on extracting the first, second, and third articles from the page and ignores the H1 tag completely. Other metrics used to accurately identify which pattern on a page is the correct one include: the max length of a string with a header span of content; the number of “anchor” links within a header span; the ratio of text runs to anchors; the total number of images within a span; the number of “big” images within a span; ratio of this span of text to the span of other header tags; and ratio of this span of text to the total page.

Page Type: DIV Tags

A much more difficult problem is the growing number of “DIV” tag pages that have some of the old TABLE HTML tags but sometimes have very few HTML tags so that a completely different approach is needed to identify articles or blog posts. DIV tags on a page usually have a ‘class name’ or ‘id’ as a tag attribute. The class name can be used to apply a page style that is defined on the page or within a cascading style sheet. Knowing the number of DIV tags and their names give very little information by themselves. Knowing exactly what a DIV tag will do within a browser with 100% accuracy will require matching the tag with the tag style and determining what the style is designed to do. This is not possible and far beyond the scope of the current parser.

The system can however accurately identify articles and posts on a page with the following process. The system builds a hashtable of all DIV class names and keeps track of the content on the page between the start and end of each DIV tag of the same name. Information that is collected for each DIV start and end include:

Number of visible text characters (not anchor text)

Number of anchors.

Number of images.

Counts of nested DIV tags.

At the end of the first PageMetrics parse the system determines how many “repeating” DIV classes there are on a page and how many of the repeating DIV repeat with the same frequency.

Consider a page that has a repeating pattern:

DIV_NAME_AAAA 1140 characters

DIV_NAME_BBBB 40 characters

DIV_NAME_CCCC 1000 characters

DIV_NAME_DDDDD 40 characters

DIV_NAME_EEEEE 70 characters

DIV_NAME_AAAA 2130 characters

DIV_NAME_BBBB 30 characters

DIV_NAME_CCCC 2000 characters

DIV_NAME_DDDDD 40 characters

DIV_NAME_EEEEE 70 characters

DIV_NAME_AAAA 4120 characters

DIV_NAME_BBBB 30 characters

DIV_NAME_CCCC 4000 characters

DIV_NAME_DDDDD 40 characters

DIV_NAME_EEEEE 70 characters

Metrics:

DIV_NAME_AAAA repeats 3 times total visible text=7390

DIV_NAME_BBBB repeats 3 times total visible text=100

DIV_NAME_CCCC repeats 3 times total visible text=7000

DIV_NAME_DDDDD repeats 3 times total visible text=120

DIV_NAME_EEEEE repeats 3 times total visible text=210

The system can look at the metrics of the page and identify the following DIV tags:

DIV_NAME_AAAA=post or article main container

DIV_NAME_BBBB=title name

DIV_NAME_CCCC=body text

DIV_NAME_DDDDD=byline?

DIV_NAME_EEEEE=timestamp?

If necessary the system looks for timestamp patterns of text such as dates and time patterns.

### Page Metrics Operation

The following description presents method steps of the present invention for determining page layout types. As in the case of HTML to RSS conversion, the operation may be implemented using processor-executable instructions for directing operation of a device under processor control. The processor-executable instructions themselves may be stored on a computer-readable medium, such as CD, DVD, flash memory, or the like, and may also be stored as a set of downloadable processor-executable instructions, for example, for downloading and installation from an Internet location (e.g., Web server).

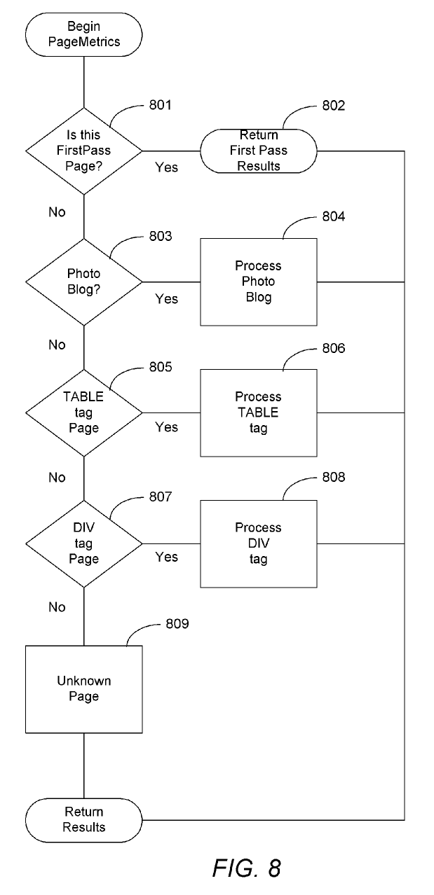

FIG. 8 is a flowchart illustrating a method 800 of the present invention for determining page layout types. After the parser reads the page, the result metrics of the page are examined to determine which major category of page layout types the page belongs in. This examination can be arranged as a sequence of tests (e.g., “if . . . else” statements or switch statement), with appropriate action taken upon identification of a particular type.

If during the first page metrics parse, at step 801, the method identifies the article content with high accuracy, then it returns a “FirstPass” article result, as indicated at step 802. In that case, the determination is completed and the method concludes with “FirstPass” as the returned result. Otherwise, the method continues. The next easiest category is to identify “Photo Blog” pages, as these have a large number of images and little text. This case is tested at step 803. If “Photo Blog” is found, the method processes the photo blog page at step 804. Thereafter, the method concludes with “Photo Blog” as the returned result. Otherwise, the method continues. The method now attempts to identify TABLE or DIV tag based layouts, at steps 805 and 807, respectively. Upon finding a TABLE tag page at step 805, the method processes the TABLE tag at step 806, and thereafter concludes with “TABLE tag” as the returned result. Similarly upon finding a DIV tag page at step 807, the method processes the DIV tag at step 808, and thereafter concludes with “DIV tag” as the returned result. Step 809 represents the fall-through or default case where no clear definition of the page type is discernable. In that case, the method returns a “best guess” of the page content. This may be done, for example, by displaying a block of visible text” from the source page.

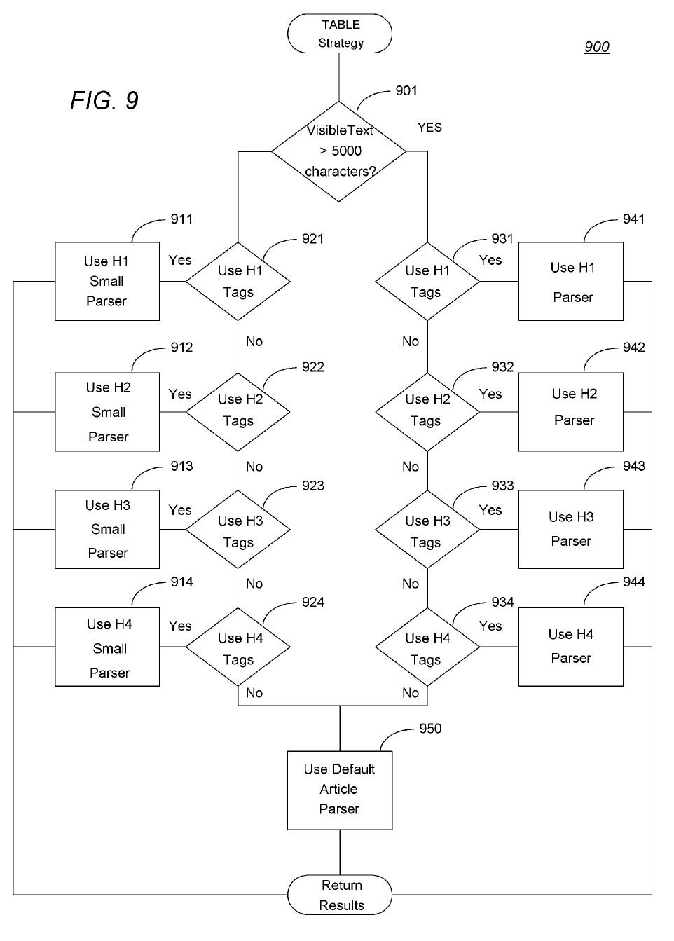

FIG. 9 is a flowchart illustrating a table strategy method 900 of the present invention for processing the TABLE page layout type. Once the major category is identified as a “TABLE” strategy, then metrics and more rules are used to resolve “ambiguous” edge metrics and make sure that the most appropriate parser is used to extract the article from the page. If no clear TABLE strategy can be identified then the “Default Article Parser” is used to look for the first “most likely” article on a page based on the length of text runs and title tags.

FIG. 9 shows a top down organization of an apparently simple task but which in fact turns out to be a task that rapidly becomes complicated when trying to solve the problem posed by determining a particular page type. The determination itself has a large number of possible outcomes. The task becomes, therefore, dividing those outcomes, one at a time, until the system reaches an appropriate target (that it is looking for). When a page is rich in content (e.g., it contains a large article, or it contains many images, or it contains a lot of anchor tags), the method may complete the determination of page type very high in the process (i.e., at the initial steps). As the page becomes more dense or fragmented, the task of identifying what the page architect had in mind becomes more difficult.

In accordance with the present invention, the method proceeds as follows. Using the previously captured page metrics, at step 901 the method looks to see whether the visible text is greater than 5000 characters. Here, the method is attempting to determine whether the page is probably a story, instead of simply a news page, a collection of headlines, or a collection of photos. If not, then the method proceeds along the logic set forth on the left-hand side of FIG. 9 commencing at 921 at FIG. 9, testing the individual cases to see which page strategy is most appropriate. Note in the figure that there are two main types of parsers: small parsers 911, 912, 913, 914 and regular (large) parsers 941, 942, 943, 944. The parsers are different in that different weightings of page attributes are applied based on whether execution of the method flows down the left-hand side (small text) or the right-hand side (regular text). Each parser is constructed as a stand-alone software object, in order to facilitate maintenance of the system. Additionally, the small parsers are designed to operate with a smaller data set (i.e., can be successful with less data input).

The difference between the small and regular parsers is perhaps best illustrated by example. Consider, for instance, a small page and a regular page, where each has multiple headlines. The small page may have only two sentences of text on the page that are important followed by an image. On the regular page, one or two headlines may be followed by several paragraphs of text. When the method processes the regular page, as soon as the method has the first well-defined headline and the first well-defined paragraph (or two), the method may stop parsing the rest of the page because it has already attained all the information that it can display on the target device (e.g., mobile phone). Additionally, it is likely that the page designer did not include two or more articles of substantial length on a single page with just one title. Therefore, for example, in the case that the method encounters a lot of visible text (greater than 5000 characters) and H1 tags/weighting (i.e., yes at 901, and at 931), the method proceeds to step 941 to use the H1 (regular) parser.

Here, the method is not merely concerned with the presence or absence of H1 tags, but is instead concerned with whether H1 tags are the predominant feature for the page relative to other tags based on previously gathered page metrics (e.g., H1Count, H1Text, H1Len, and H1Ratio). Consider the following program logic (rule):

1: if (parser.countH1Tags < 50 &&
2: parser.insideH1ratio > parser.insideH2ratio && parser.insideH1ratio >
3: parser.insideH3ratio && parser.insideH1ratio > parser.insideH4ratio
&&
4: parser.insideH1Longest > parser.insideH2Longest)
5: {
6: ruleFired = 20;
7: return
8: PAGEMETRICS_PAGETYPE_BLOG_GENERIC_H1;
9: }
10: if (parser.countH2Tags < 50
&&
11: parser.insideH2ratio > parser.insideH1ratio && parser.insideH2ratio >
12: parser.insideH3ratio && parser.insideH2ratio > parser.insideH4ratio
&&
13: parser.insideH2Longest > parser.insideH2Longest &&
parser.insideH2Longest
14: > > parser.insideH3Longest)
15: {
16: ruleFired = 21;
17: return
18: PAGEMETRICS_PAGETYPE_BLOG_GENERIC_H2;
19: }
20: if (parser.countH3Tags < 50
&&
21: parser.insideH3ratio > parser.insideH1ratio && parser.insideH3ratio >
22: parser.insideH2ratio
23: &&
parser.insideH3ratio >
24: parser.insideH4ratio && parser.insideH3Longest >
parser.insideH2Longest
25: &&
parser.insideH3Longest
26: > > parser.insideH4Longest)
27: {
28: ruleFired = 22;
29: return
30: PAGEMETRICS_PAGETYPE_BLOG_GENERIC_H3;
31: }

Here, the program logic tests the various metrics for determining what page type to return. Once the page type has been determined, the respective parser is invoked for performing page type-specific processing. The H1 parser, for example, extracts the heading (based on extracting information between the H1 tags) and the accompanying article text (based on extracting information between subsequent paragraph tags). This extracted information may be captured to a buffer (e.g., upon reaching a preset limit, such as 200 words), for matching the information that is to be sent to the ultimate target screen that is to receive it (e.g., mobile phone screen).

Processing by the small parser, in contrast, is more difficult. For example, if the H1 small parser were to wait for 200 words in the page, the parser will never find them. Therefore, the program logic at step 901 (i.e., visible text greater than five thousand characters) pre-screens the page, so that the small parsers may all operate on the assumption that the page does not include a lot of text and instead focus their attention on looking for other (“small text”) things, such as a photo blog page. For example in the case of the H1 small parser as shown at 911 at FIG. 9, upon encountering a photo blog page, as soon as the parser extracts a nice headline (e.g., some minimum number of characters) and nice image (e.g., JPEG image of at least a minimum height and width), followed by a sentence or two of text (itself in turn followed by yet another headline), the parser may return that as the information to be sent to the target device. Note in contrast for the regular H1 parser as shown at 941, the parser logic is less concerned about images as the method has already determined that the page contains a lot of text, and therefore it is unlikely that the page contains a lot of large pictures (appropriate for sending to the target device).

It is possible that a given page may not employ H1 tags as a predominant feature. In fact, the typical Web page will not use the full complement of H1-4 heading tags. Therefore in the case that an H1 tag is not the predominant feature for the page, the method determines whether H2 tags predominate the page, by performing step 922 for small text page (less than 5000 characters, such as a photo blog) and step 932 for regular text page. If H2 tag weighting is to be applied, the method proceeds to the corresponding H2 parser (parser 942 for regular text page, and parser 912 for small text page). Again, tag-appropriate logic is embodied in each parser (e.g., see handletext handler below), so that the method can extract exactly the correct text/images that is appropriate for the given page. In this manner, the method may continue processing the page for H3 tags (tested at steps 923 and 933) and H4 tags (tested at steps 924 and 934), with appropriate parsers invoked (parsers 913 and 943, and parsers 914 and 944, respectively).

### Source Code Implementation

Page type determination is performed by a “GetPageType( )” method of the PageMetrics class. The method looks at the page metrics and applies rules to return the specific strategy most likely to result in the highest quality article content being returned to the device. The method is implemented in Java syntax as follows:

| | |
|---|---|
| 1: | public int GetPageType( ) |
| 2: | { |
| 3: | |
| 4: | if (parser.blog_source > 0) |
| 5: | { |
| 6: | ruleFired = 2; |
| 7: | if (parser.sourceName.indexOf(“Flicker”) != −1) |
| 8: | return PAGEMETRICS_PAGETYPE_FLICKER; |
| 9: | else |
| 10: | return |
| | PAGEMETRICS_PAGETYPE_BLOG_GENERIC_H2; |
| 11: | } |
| 12: | if (parser.countFrameset > 0) |
| 13: | { |
| 14: | ruleFired = 3; |
| 15: | return PAGEMETRICS_PAGETYPE_IFRAME; |
| 16: | } |
| 17: | if (parser.totalVisText < 50) { |
| 18: | ruleFired = 4; |
| 19: | return PAGEMETRICS_PAGETYPE_IMAGE; |
| 20: | } |
| 21: | if (parser.totalVisText > 5000) |
| 22: | { |
| 23: | if (parser.firstBody.length( ) > 1000) |
| 24: | { |
| 25: | ruleFired = 5; |
| 26: | return PAGEMETRICS_PAGETYPE_FIRSTPASS; |
| 27: | } |
| 28: | // ... |
| 29: | } |

The GetPageType method or routine is invoked by the PageMetrics class, where the system is looking at all of the metrics that have been collected during a first pass through the page. The method works through the important architectural features of the page (under exam) as follows. At line 4 of GetPageType, the method attempts to determine whether the source page is from a known blog source (e.g., www.bloglines.com). If yes (true), then the method sets a “rule fired” flag at line 6. If the page is from Flicker (Web site), then the method returns PAGEMETRICS_PAGETYPE_FLICKER. Otherwise, the method returns PAGEMETRICS_PAGETYPE_BLOG_GENERIC_H2. At line 12, the method examines the Frameset count for the page. Framesets divide a page up into small frames. Each frame is an important page layout feature that requires its own strategy. In the case that one or more framesets is present, the method sets the “rule fired” flag at line 14 and returns PAGEMETRICS_PAGETYPE_IFRAME at line 15. At line 17, the method examines whether the amount of visible text is less than 50 characters. If yes, the “rule fired” flag is said at line 18, and the method returns PAGEMETRICS_PAGETYPE_IMAGE at line 19. On the other hand, if the visible text is greater than 5000 (tested at line 21), then the method proceeds to test whether the length of the first body (line 23) is greater than 1000 characters. (First body refers to the first body of text, such as an article; it does not refer to HTML body tags.) If yes, the “rule fired” flag is set at line 25, and the method returns PAGEMETRICS_PAGETYPE_FIRSTPASS. A “first pass” page type is one where the system is able to extract good text (good headline and good body text) on the first pass. In this manner, the method may proceed to other rules for bracketing or identifying the page type.

Each parser includes a handletext handler or routine. The particular strategy followed by a given handletext handler depends on the current tag weighting applied (i.e., whether H1, H2, H3, or H4 strategy). Depending on the particular parser, the logic of handletext can be simple or very complex, for example:

| | |
|---|---|
| 1: | protected void handleText(int c) throws IOException |
| 2: | { |
| 3: | boolean done = false; |
| 4: | StringBuffer sb = new StringBuffer( ); |
| 5: | sb.append((char)c); |
| 6: | for (;;) |
| 7: | { |
| 8: | if (done) break; |
| 9: | c = _reader.read( ); |
| 10: | switch (c) |
| 11: | { |
| 12: | case ‘<’: |
| 13: | _reader.unread(‘<’); |
| 14: | done = true; |
| 15: | break; |
| 16: | case −1: |
| 17: | done = true; |
| 18: | break; |
| 19: | case 27: |
| 20: | sb.append(_parserUtils.handleEscape( )); |
| 21: | break; |
| 22: | default: |
| 23: | sb.append((char) c); |
| 24: | break; |
| 25: | } |
| 26: | } |
| 27: | if (isInsideTitle) |
| 28: | { |
| 29: | String str = sb.toString( ).trim( ); |
| 30: | if (visibleChars(str)) |
| 31: | { |
| 32: | if (divTitle.length( ) == 0) |
| 33: | { |
| 34: | divTitle += str; |
| 35: | } |
| 36: | } |
| 37: | return; |
| 38: | } |
| 39: | if (isInsideBody) |
| 40: | { |
| 41: | String str = sb.toString( ).trim( ); |
| 42: | if (lastTagWasBreak == true && insideAnchor == true) |
| 43: | return; |
| 44: | |
| 45: | if (visibleChars(str) && insideOption == false) |
| 46: | { |
| 47: | divBody += str; |
| 48: | divBody += “ ”; |
| 49: | if (str.length( ) > 0) |
| 50: | lastTagWasBreak = false; |
| 51: | } |
| 52: | return; |
| 53: | } |
| 54: | } |

This handler or method serves to extract visible text. Lines 1-26 of the method employ simple logic to extract visible text, up to the point where a break character is encountered. Depending on flags set, the handler makes a determination whether the text is inside the page title or inside the page body. Specifically, lines 27-38 include logic for extracting the text from a title. Here, this logic operates when the handler is inside a title (i.e., the title has started but not yet ended). Once the title text (if any) has been processed, the method proceeds to lines 39-54 to extract text inside the page's body. If the last tag was a break and the handler is processing inside an anchor, then the handler simply returns at line 43. Otherwise, the handler proceeds to add the visible characters to a body (buffer) that it is building up in memory (line 47), provided that the method is not inside an HTML Option (i.e., menu item, tested at line 45). In this manner, the handler builds up a title (buffer) and a body (buffer). Depending on the parser, the handler may build up other buffers as well.

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

What is claimed is:

1. A method for delivering Web content to a limited-capability mobile device, the method comprising:
receiving from the limited-capability mobile device a request for information of interest from the Web;
in response to the request, retrieving a target Web page containing the information of interest;
examining the Web page to determine a particular page type;
based on the particular page type, selecting a page strategy for extracting the information of interest from the Web page;
based on the selected page strategy, extracting the information of interest from the Web page;
formatting the information of interest, so that the information of interest is optimized for display on the limited-capability mobile device; and
transmitting the formatted information of interest to the limited-capability mobile device, so that that information may be conveniently displayed on the limited-capability mobile device.

2. The method of claim 1, wherein said formatting step comprises:
formatting the information of interest into RSS (Rich Site Summary) format, so that the information of interest is optimized for display on the limited-capability mobile device.

3. The method of claim 2, wherein the formatted information of interest comprises an XML-based RSS feed.

4. The method of claim 2, wherein the Web page itself lacks RSS support.

5. The method of claim 2, wherein the information of interest is formatted “on demand” into RSS, while a user is operating the limited-capability mobile device.

6. The method of claim 1, wherein said receiving step comprises:
receiving from a feature phone a request for information of interest from the Web.

7. The method of claim 1, further comprising:
displaying the formatted information of interest at the limited-capability mobile device using a browser-less display.

8. The method of claim 1, further comprising:
first attempting to locate an RSS feed for the Web page that is suitable for extracting the information of interest.

9. The method of claim 1, wherein the request comprises a URL.

10. The method of claim 1, wherein the examining, selecting, extracting, and formatting steps are performed at a server computer, which exists separately from the Web page.

11. The method of claim 1, further comprising:
displaying the formatted information of interest at an RSS (Rich Site Summary) reader running on the limited-capability mobile device.

12. The method of claim 1, wherein the information of interest comprise articles for a given content page category.

13. The method of claim 12, wherein the content page category comprises a sports category.

14. The method of claim 12, wherein the content page category comprises a news category.

15. The method of claim 1, wherein the request comprises a Web search request, and wherein the information of interest comprises one or more Web pages returned by a search engine in response to the search request.

16. A system for delivering Web content, the system comprising:
a limited-capability mobile device; and
server modules for:
receiving from the limited-capability mobile device a request for information of interest from the Web;
retrieving a target Web page containing the information of interest in response to the request;
examining the Web page to determine a particular page type;
selecting a page strategy for extracting the information of interest from the Web page based on the particular page type;
extracting the information of interest from the Web page based on the selected page strategy;
formatting the information of interest, so that the information of interest is optimized for display on the limited-capability mobile device; and
transmitting the formatted information of interest to the limited-capability mobile device, so that that information may be conveniently displayed on the limited-capability mobile device.

17. The system of claim 16, wherein the server module for formatting formats the information of interest into RSS (Rich Site Summary) format, so that the information of interest is optimized for display on the limited-capability mobile device.

18. The system of claim 17, wherein the formatted information of interest comprises an XML-based RSS feed.

19. The system of claim 17, wherein the Web page itself lacks RSS support.

20. The system of claim 17, wherein the information of interest is formatted “on demand” into RSS, while a user is operating the limited-capability mobile device.

21. The system of claim 16, wherein the limited-capability mobile device comprises a feature phone.

22. The system of claim 16, wherein the limited-capability mobile device includes a browser-less display for displaying the formatted information of interest.

23. The system of claim 16, wherein the server module for retrieving first attempts to locate an RSS feed for the Web page that is suitable for extracting the information of interest.

24. The system of claim 16, wherein the request comprises a URL.

25. The system of claim 16, wherein the limited-capability mobile device includes an RSS (Rich Site Summary) reader for displaying the formatted information of interest.

26. The system of claim 16, wherein the information of interest comprise articles for a given content page category.

27. The system of claim 26, wherein the content page category comprises a sports category.

28. The system of claim 26, wherein the content page category comprises a news category.

29. The system of claim 16, wherein the request comprises a Web search request, and wherein the information of interest comprises one or more Web pages returned by a search engine in response to the search request.

30. The system of claim 29, wherein the server module for formatting transforms Web pages returned by the search engine into the formatted information of interest.

31. A method for on-demand formatting of a Web page into an RSS (Rich Site Summary) feed, the method comprising:
receiving a request from a client device for an RSS feed from the Web page;
parsing the Web page to determine a page strategy for extracting information from the Web page for use as an RSS feed;
based on the determined page strategy, extracting the information and reformatting it on-the-fly into an RSS feed; and
transmitting the RSS feed to the client device.

32. The method of claim 31, wherein the parsing step includes:
determining information objects present in the Web page.

33. The method of claim 31, wherein the parsing step includes:
tracking page metrics of the Web page, for characterizing important characteristics of the page.

34. The method of claim 33, wherein page metrics include information about page construction.

35. The method of claim 34, wherein information about page construction includes information about use of JavaScript.

36. The method of claim 34, wherein information about page construction includes information about use of framesets.

37. The method of claim 34, wherein information about page construction includes information about use of stylesheets.

38. The method of claim 33 wherein page metrics include information about page content.

39. The method of claim 38, wherein information about page content includes information about text runs.

40. The method of claim 38, wherein information about page content includes information about title runs.

41. The method of claim 33, wherein page metrics includes information about page layout.

42. The method of claim 41, wherein information about page layout includes information about images present in the Web page.

43. The method of claim 41, wherein information about page layout includes information about tables present in the Web page.

44. The method of claim 41, wherein information about page layout includes information about anchors present in the Web page.

45. The method of claim 41, wherein information about page layout includes information about scripts present in the Web page.

46. The method of claim 41, wherein information about page layout includes information about applets present in the Web page.

47. The method of claim 41, wherein information about page layout includes information about forms present in the Web page.

48. The method of claim 31, further comprising:
adding dynamic navigation tags supporting navigation of the RSS feed at the client device.

49. The method of claim 31, wherein page strategy is based at least in part on heading tags present in the Web page.

50. The method of claim 31, wherein page strategy is based at least in part on visible text present in the Web page.
